(19) United States
(12) Patent Application Publication
(10) Pub. No.: US 2011/0155006 A1
(43) Pub. Date: Jun. 30, 2011

(54) INTERLOCKING PRINTING SLEEVES

(75) Inventors: John A. Pratt, Pleasant Plains, AR (US); Terry L. Mitchell, Searcy, AR (US); John W. Franks, Searcy, AR (US)

(73) Assignee: BRYCE CORPORATION, Memphis, TN (US)

(21) Appl. No.: 12/982,135

(22) Filed: Dec. 30, 2010

Related U.S. Application Data
(60) Provisional application No. 61/291,659, filed on Dec. 31, 2009.

(51) Int. Cl. B41F 31/00; B41L 1/02

(52) U.S. Cl. 101/351.7; 101/485

(57) ABSTRACT

A printing sleeve mandrel assembly for use in a rotary printing press is disclosed. The printing sleeve mandrel assembly includes a mandrel having an outer circumference and a plurality of printing sleeves each operable to be removeably disposed along the outer circumference of the mandrel. Each of the plurality of printing sleeves includes a first end and a second end wherein at least one of the first end and the second end includes an engagement mechanism, each engagement mechanism for removeably coupling with the engagement mechanism of an adjacent printing sleeve so that each of the plurality of printing sleeves are operable to rotate in conjunction with the other printing sleeves.

### CROSS-REFERENCE TO RELATED APPLICATION

This application claims priority to provisional application Ser. No. 61/291,659 filed Dec. 31, 2009 entitled Interlocking Printing Sleeves, the entire contents of which is incorporated herein by reference.

### FIELD

This invention relates to the field of rotary printing presses. More particularly, this invention relates to interlocking printing sleeves for rotary printing presses.

### BACKGROUND

Rotary printing presses in the prior art accommodate printing cylinders or mandrels having multiple printing plates mounted on a single printing sleeve. In order to maximize production with these printing presses, the printing plates preferably cover the entire surface of the printing sleeve. However, these types of printing presses limit a production run to the printing plates already mounted to the printing sleeve. If a printing plate needs to be replaced or certain printing plates need to be reconfigured (i.e., a printing plate needs to be replaced with a printing plate with a different design thereon for a different job order), the entire printing sleeve must be removed from the printing press, the printing plates reconfigured, and then the printing sleeve is remounted. This causes increased downtime, plate wear, and additional labor. What is needed is a printing press that allows for replacing selected printing plates from a mandrel without having to remove and reconfigure one long printing sleeve.

### SUMMARY

Embodiments of the present invention include a rotary printing press with multiple interlocking printing sleeves disposed along the outer circumference of a mandrel. Each order or plate can be mounted on one individual sleeve that can be interlocked into other sleeves. In order to change the configuration of a production run, the user may simply pull one sleeve off of the printing cylinder and slide another (perhaps more urgent) order on the mandrel. Thus, the interlocking sleeve technology of the present invention will allow a user to run virtually any combination of orders on the multiple printing sleeves without having to remount all the plates or run excess material that is not needed. Among other advantages, this allows the user to be much more flexible when unexpected orders are received.

In one embodiment of the invention, a printing sleeve mandrel assembly for use in a rotary printing press is disclosed. The printing sleeve mandrel assembly includes a mandrel having an outer circumference and a plurality of printing sleeves each operable to be removeably disposed along the outer circumference of the mandrel. Each of the plurality of printing sleeves includes a first end and a second end wherein at least one of the first end and the second end includes an engagement mechanism, each engagement mechanism for removeably coupling with the engagement mechanism of an adjacent printing sleeve so that each of the plurality of printing sleeves are operable to rotate in conjunction with the other printing sleeves.

In certain embodiments, each of the plurality of printing sleeves is a hollow cylindrical tube having an inner circumference, the inner circumference being substantially similar to the outer circumference of the mandrel. The mandrel may further include air conduits disposed beneath the outer circumference of the mandrel and a plurality of air ports disposed within the outer circumference of the mandrel, the air conduits for pumping air into the mandrel and through the air ports so that the plurality of printing sleeves are operable to slide along the outer circumference of the mandrel so that each printing sleeve may reach a desired position. At least one of the printing sleeves may include at least one groove disposed within at least one of the first end and the second end for allowing the pumped air to escape the printing sleeve mandrel assembly. At least one of the ends of the printing sleeves having one of the grooves may include a slit disposed adjacent the groove for allowing the pumped air released from the air ports to flow through the slit to the groove. The slit may be disposed substantially along the inner circumference of the end of the printing sleeve.

In certain embodiments, the plurality of printing sleeves includes a first printing sleeve and the first end of the first printing sleeve includes an attachment mechanism for removeably coupling the first printing sleeve to the mandrel so that the first printing sleeve is operable to rotate in conjunction with the mandrel.

In other embodiments, the plurality of printing sleeves includes a first printing sleeve having the engagement mechanism disposed at the second end of the first printing sleeve and an attachment mechanism disposed at the first end of the first printing sleeve, the attachment mechanism for removeably coupling the first printing sleeve to the mandrel so that the first printing sleeve is operable to rotate in conjunction with the mandrel. A second printing sleeve is adjacent the first printing sleeve and includes a first engagement mechanism disposed at the first end of the second printing sleeve and a second engagement mechanism disposed at the second end of the second printing sleeve, the first engagement mechanism of the second printing sleeve for removeably coupling with the engagement mechanism of the first printing sleeve so that the second printing sleeve is operable to rotate in conjunction with the first printing sleeve. A third printing sleeve is adjacent the second printing sleeve and includes the engagement mechanism disposed at the first end of the third printing sleeve for removeably coupling with the second engagement mechanism of the second printing sleeve so that the third printing sleeve is operable to rotate in conjunction with the second printing sleeve and the engagement mechanism of the first printing sleeve when the second printing sleeve is removed from the mandrel assembly so that the third printing sleeve is operable to rotate in conjunction with the first printing sleeve.

In certain embodiments, the engagement mechanisms include at least one of a plurality of teeth and a plurality of tooth receivers, the plurality of teeth being operable to couple with the plurality of tooth receivers of the adjacent printing sleeve.

In another embodiment of the invention, a mandrel assembly for use in a rotary printing press is disclosed having a mandrel having an outer circumference, a first printing sleeve operable to be disposed along the outer circumference of the mandrel, the first printing sleeve including a first end and a second end, the second end having an engagement mechanism, and a second printing sleeve operable to be removeably disposed along the outer circumference of the mandrel and adjacent the first printing sleeve. The second printing sleeve includes a first end having an engagement mechanism for removeably coupling with the engagement mechanism of the first printing sleeve so that the second printing sleeve is operable to rotate in conjunction with the first printing sleeve when the mandrel is rotated.

In certain embodiments, the first end of the first printing sleeve may include an attachment mechanism for coupling the first printing sleeve to the mandrel so that the first printing sleeve is operable to rotate in conjunction with the mandrel. The second printing sleeve may include a second end having a second engagement mechanism, and the mandrel assembly further includes a third printing sleeve operable to be removeably disposed along the outer circumference of the mandrel, the third printing sleeve including a first end having an engagement mechanism for removeably coupling to both the second engagement mechanism of the second printing sleeve so that the third printing sleeve is operable to rotate in conjunction with the second printing sleeve when the mandrel is rotated and the engagement mechanism of the first printing sleeve when the second printing sleeve is not disposed along the outer circumference of the mandrel so that the third printing sleeve is operable to rotate in conjunction with the first printing sleeve when the mandrel is rotated.

In certain embodiments, the first printing sleeve and the second printing sleeve is a hollow cylindrical tube having an inner circumference, the inner circumference being substantially similar to the outer circumference of the mandrel. The mandrel may include air conduits disposed beneath the outer circumference of the mandrel and a plurality of air ports disposed within the outer circumference of the mandrel, the air conduits for pumping air into the mandrel and through the air ports so that the second printing sleeve may slide along the outer circumference of the mandrel to reach a desired position.

In certain embodiments, the engagement mechanism of the first printing sleeve includes a plurality of teeth and the engagement mechanism of the second printing sleeve includes a plurality of tooth receivers, the plurality of teeth being operable to removeably couple with the plurality of tooth receivers so that the second printing sleeve is operable to rotate in conjunction with the first printing sleeve when the mandrel is rotated.

In another aspect of the invention, a method for permitting individual printing sleeves to be selectively replaced on a printing sleeve mandrel assembly is disclosed. The method includes the steps of providing a mandrel having an outer circumference; providing a first printing sleeve disposed along the outer circumference of the mandrel, the first printing sleeve including a second end having an engagement mechanism; providing a second printing sleeve disposed along the outer circumference of the mandrel adjacent the first printing sleeve, the second printing sleeve including a first end having an engagement mechanism; coupling the engagement mechanism of the first printing sleeve with the engagement mechanism of the second printing sleeve so that the second printing sleeve is operable to rotate in conjunction with the first printing sleeve when the mandrel is rotated; decoupling the engagement mechanism of the first printing sleeve from the engagement mechanism of the second printing sleeve; removing the second printing sleeve from the mandrel; providing a third printing sleeve disposed along the outer circumference of the mandrel and adjacent the first printing sleeve, the second printing sleeve including a first end having an engagement mechanism; and coupling the engagement mechanism of the third printing sleeve with the engagement mechanism of the first printing sleeve so that the third printing sleeve is operable to rotate in conjunction with the first printing sleeve when the mandrel is rotated.

In certain embodiments, the method may further include providing an attaching printing sleeve disposed along the outer circumference of the mandrel, the attaching printing sleeve including a first end having an attachment mechanism and a second end having an engagement mechanism, the attachment mechanism for coupling the attaching printing sleeve to the mandrel so that the attaching printing sleeve is operable to rotate in conjunction with the mandrel, the engagement mechanism for coupling with an engagement mechanism disposed at the first end of the first printing sleeve so that the first printing sleeve is operable to rotate in conjunction with the attaching printing sleeve when the mandrel is rotated.

In certain embodiments, the mandrel includes air conduits disposed beneath the outer circumference of the mandrel and a plurality of air ports disposed within the outer circumference of the mandrel. In this embodiment, the method may further include pumping air through the air conduits so that the pumped air is released from the mandrel through the air ports; and sliding at least one of the first printing sleeve, the second printing sleeve, and the third printing sleeve into a desired position along the outer circumference of the mandrel using the pumped air released through the air ports as a lubricant. At least one of the first printing sleeve, the second printing sleeve, and the third printing sleeve may also include at least one groove disposed within at least one of the ends for allowing the pumped air to escape the printing sleeve mandrel assembly. At least one of the ends of the printing sleeves having one of the grooves may include a slit disposed adjacent the groove for allowing the pumped air released through the air ports to flow through the slit to the groove.

### BRIEF DESCRIPTION OF THE DRAWINGS

Further advantages of the invention are apparent by reference to the detailed description in conjunction with the figures, wherein elements are not to scale so as to more clearly show the details, wherein like reference numbers indicate like elements throughout the several views, and wherein:

FIG. 1 is a front view of an interlocking sleeve mandrel assembly having a plurality of interlocking printing sleeves each being in unengaged positions with respect to adjacent interlocking printing sleeves;

FIG. 2 is a perspective view of an interlocking printing sleeve having a mandrel pin receiver for attaching the interlocking printing sleeve to the mandrel;

FIG. 3 is a perspective view of an interlocking printing sleeve having teeth and teeth receivers located at opposing ends of the sleeve;

FIG. 4 is a perspective view of one end of an interlocking printing sleeve having a groove for allowing air to be released from the interlocking sleeve mandrel assembly; and

FIG. 5 is an end view of an interlocking printing sleeve having the groove shown in FIG. 4 and a slit disposed beneath the inner circumference of the sleeve.

### DETAILED DESCRIPTION

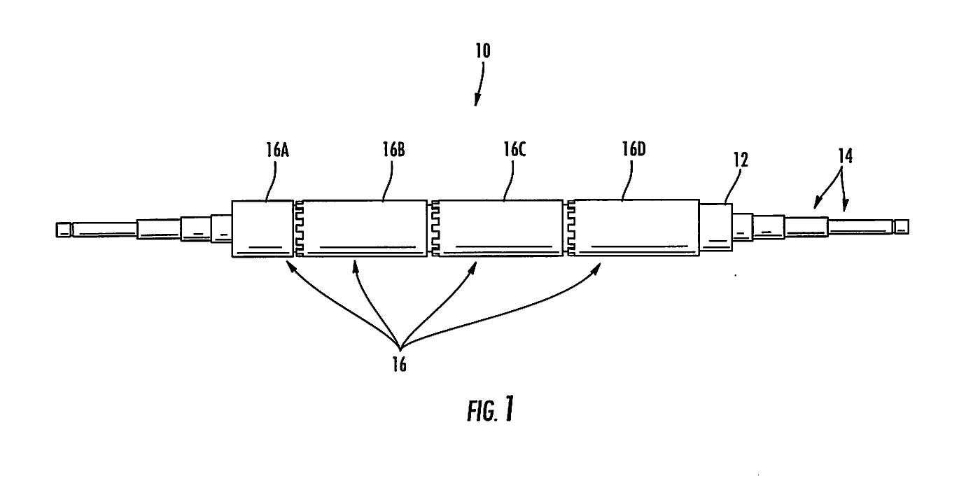

Referring to FIG. 1, an interlocking printing sleeve mandrel assembly 10 for use in a rotary press such as a printing press has a mandrel 12 with multiple, tiered components 14. A plurality of interlocking printing sleeves 16 are each removeably disposed along the outer circumference of the mandrel 12. The interlocking printing sleeves 16 are hollow cylindrical tubes having an inner circumference that is precisely machined to fit closely against the outer circumference of the mandrel 12. The printing sleeves 16 are operable to couple with one another thereby eliminating potential rotation of a sleeve 16 on the mandrel 12 with respect to another sleeve 16.

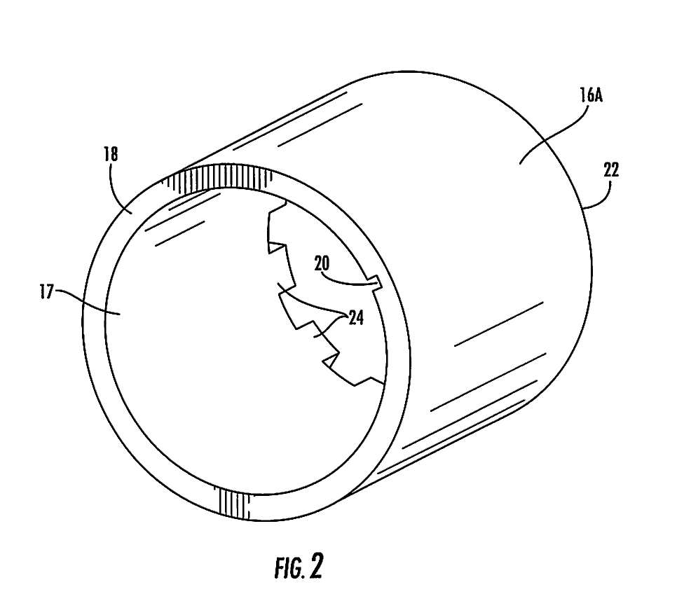

Sleeve 16A, as shown in FIGS. 1 and 2, is typically positioned on the mandrel 12 before the other sleeves. Sleeve 16A, also referred to as an attaching sleeve, includes a first end 18 and a second end 22. As shown in FIG. 2, the first end 18 includes a pin receiver 20 in the first end's 18 inner circumference 17. The pin receiver 20 is configured for receiving a pin (not shown), which is part of the mandrel 12. The coupling of the mandrel pin and the pin receiver 20 of sleeve 16A removeably attaches the coupled printing sleeves 16 by preventing sleeve 16A from rotating in relation to the mandrel 12 while also ensuring sleeve 16A rotates in conjunction with mandrel 12. While sleeve 16A and mandrel 12 are described as having respective pin receivers and pins for coupling sleeve 16A to mandrel 12, other attachment mechanisms are possible and within the scope of the present invention including clamps, screws, etc. The second end 22 of sleeve 16A includes several tooth receivers 24. In one embodiment, these tooth receivers are also formed along the inner circumference 17 of sleeve 16A.

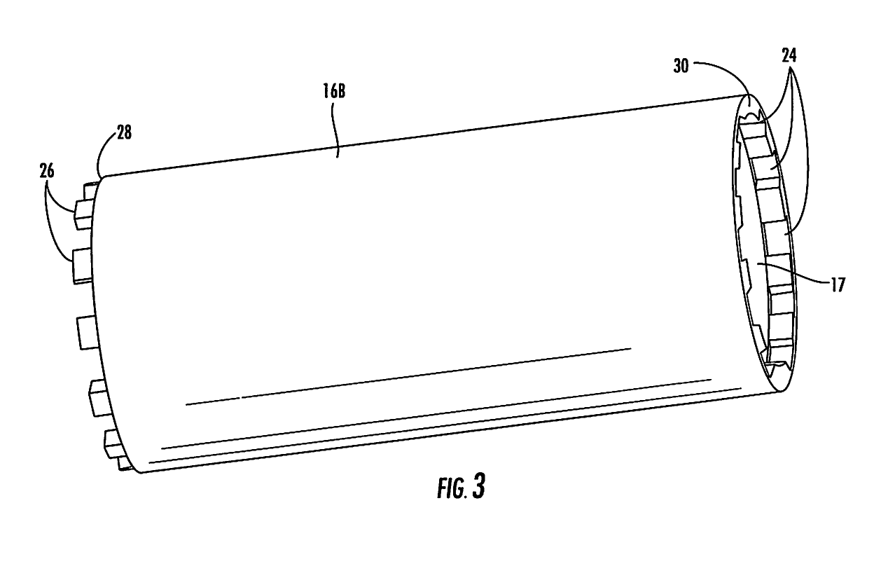

Referring to FIGS. 1 and 3, sleeve 16B has several teeth 26 that extend from a first end 28 of sleeve 16B. Sleeve 16B is positioned on the mandrel 12 adjacent sleeve 16A, and sleeve 16A and sleeve 16B are joined by coupling the teeth 26 of sleeve 16B with the tooth receivers 24 of sleeve 16A. The coupling of the teeth 26 and the tooth receivers 24 ensures sleeve 16B rotates in conjunction with sleeve 16A, and thereby, in conjunction with mandrel 12 via the pin coupling. Sleeve 16B also has a second end 30 having several tooth receivers 24 formed along the second end's 30 inner circumference 17. These tooth receivers 24, similar to the tooth receivers 24 of sleeve 16A, are configured for coupling with several teeth 26 of another adjacent sleeve 16, such as sleeve 16C shown in FIG. 1.

Similar to sleeve 16B, sleeves 16C and 16D each have first and second ends having several teeth 26 and defining several tooth receivers 24 respectively. Each successive sleeve 16 is fitted onto the mandrel 12 and coupled with the previously fitted adjacent sleeve 16. The sleeves 16 may be of various lengths so as to accommodate printing plates of various sizes. The printing plates are attached to the individual sleeves using techniques known to those of skill in the art. A printing plate can remain attached to a particular sleeve 16 that is part of the interlocking sleeve mandrel assembly 10, and, depending on the next printing job to be run on the printing press, the sleeve 16 can be removed and replaced with another sleeve 16 having another desired printing plate attached. In certain embodiments, the removed sleeve 16 can be stored with a printing plate attached until the attached printing plate is needed again, and needs only to be repositioned on a mandrel 12 for use when needed.

Similar to sleeve 16A as shown in FIG. 2, sleeve 16D could also include a pin receiver 20, or other suitable mechanisms, in the second end's 22 inner circumference 17. The pin receiver 20 is configured for receiving a pin (not shown), which is part of the mandrel 12. The coupling of the mandrel pin and the pin receiver 20 of sleeve 16D removeably attaches the coupled printing sleeves 16 by preventing sleeve 16D from rotating in relation to the mandrel 12 while also ensuring sleeve 16D rotates in conjunction with mandrel 12.

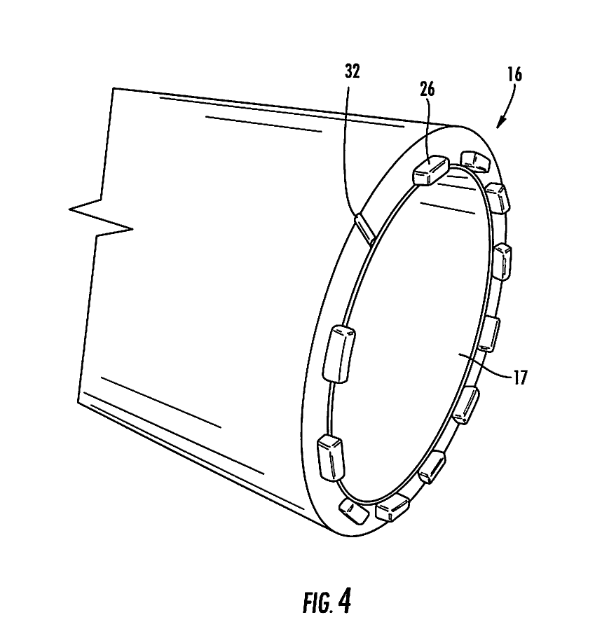

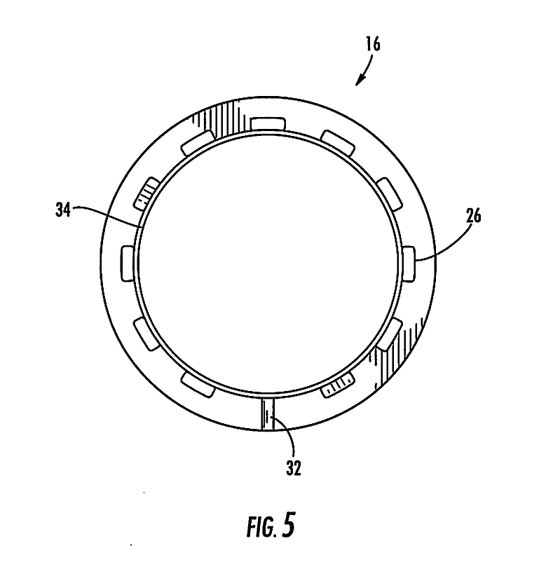

In similar embodiments of the invention, the first sleeve 16A, for example, may include several teeth 26 instead of several tooth receivers 24, and the first end 28 of sleeve 16B may include several tooth receivers 24 for coupling with the teeth 26 of the first sleeve 16A. Also, the size and shape of the teeth 26 receivers and tooth receivers 24 may vary. For example, the teeth 26 and tooth receivers 24 as shown in FIGS. 2-3 have different configurations than the teeth 26 and tooth receivers 24 shown in FIGS. 4-5. Furthermore, while the ends of the sleeves are described as having a plurality of teeth 26 or a plurality of tooth receivers 24, other engagement mechanisms are possible and within the scope of the present invention including providing clamping mechanisms, screwing mechanisms, etc. Accordingly, the particular configuration of the end of a sleeve 16 (i.e., whether the end includes tooth receivers 24, teeth 26, or other engagement mechanisms) is interchangeable so long as the end will couple with the configuration of an opposing end of a sleeve 16 adjacent to it.

In another embodiment of the invention, an air system is utilized for removing and replacing the sleeves 16. As discussed above, the sleeves 16 are machined to very tight tolerances such that the inner circumference 17 of the sleeve 16 and the outer circumference of the mandrel 12 are nearly equal. In order to fit the sleeves 16 around the mandrel 12, air is pumped into the mandrel 12, for example, through air conduits disposed beneath the outer circumference of the mandrel 12. The air then exits the mandrel 12 through a plurality of air ports located on the outer circumference of the mandrel 12. As the sleeve 16 is fitted onto the mandrel 12, the air released from the air ports acts as a lubricant and allows the sleeve 16 to “slide” along the mandrel 12 until it reaches the desired position. After all the sleeves 16 are fitted around the mandrel 12 in their desired positions and are coupled with the other sleeve 16s, the air pumped into the mandrel 12 may be stopped.

Referring to FIGS. 4-5, one or more of the sleeves 16 may include a groove 32 cut into one or both ends of the sleeves 16. The groove 32 allows the air released from the outer circumference of the mandrel 12 to escape the interlocking sleeve mandrel assembly 10, thereby allowing the sleeves 16 to couple tightly with the mandrel 12 and with one another. As shown in FIG. 4, the groove 32 may replace and take the position of one of the teeth 26. In this embodiment, the air released from the mandrel 12 may flow into the gap formed by the tooth receiver 24 in one sleeve and out the groove 32 of the adjacent sleeve 16 that took the place of the opposing tooth 26.

The sleeves 16 may also include a slit 34 disposed on the ends of the sleeves adjacent the inner circumference 17 of the sleeve 16. The slits 34 allow air captured between the mandrel 12 and the sleeves 16 as the sleeves 16 are slid into place to flow through the slits 34 and escape from the sleeves 16 through the groove 32 once the sleeves 16 are locked together on the mandrel 12. This limits the sleeves 16 from pushing away from each other after they have been locked together.

The foregoing description of preferred embodiments for this invention has been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A printing sleeve mandrel assembly for use in a rotary printing press comprising:
a mandrel having an outer circumference; and
a plurality of printing sleeves each operable to be removeably disposed along the outer circumference of the mandrel, each of the plurality of printing sleeves having a first end and a second end wherein at least one of the first end and the second end includes an engagement mechanism, each engagement mechanism for removeably coupling with the engagement mechanism of an adjacent printing sleeve so that each of the plurality of printing sleeves are operable to rotate in conjunction with the other printing sleeves.

2. The mandrel assembly of claim 1 wherein each of the plurality of printing sleeves is a hollow cylindrical tube having an inner circumference, the inner circumference being substantially similar to the outer circumference of the mandrel.

3. The mandrel assembly of claim 2 wherein the mandrel includes air conduits disposed beneath the outer circumference of the mandrel and a plurality of air ports disposed within the outer circumference of the mandrel, the air conduits for pumping air into the mandrel and through the air ports so that the plurality of printing sleeves are operable to slide along the outer circumference of the mandrel so that each printing sleeve may reach a desired position.

4. The mandrel assembly of claim 3 wherein at least one of the printing sleeves includes at least one groove disposed within at least one of the first end and the second end for allowing the pumped air to escape the printing sleeve mandrel assembly.

5. The mandrel assembly of claim 4 wherein at least one of the ends of the printing sleeves having one of the grooves includes a slit disposed adjacent the groove for allowing the pumped air released from the air ports to flow through the slit to the groove.

6. The mandrel assembly of claim 5 wherein the slit is disposed substantially along the inner circumference of the end of the printing sleeve.

7. The mandrel assembly of claim 1 wherein the plurality of printing sleeves includes a first printing sleeve and the first end of the first printing sleeve includes an attachment mechanism for removeably coupling the first printing sleeve to the mandrel so that the first printing sleeve is operable to rotate in conjunction with the mandrel.

8. The mandrel assembly of claim 1 wherein the engagement mechanisms include at least one of a plurality of teeth and a plurality of tooth receivers, the plurality of teeth being operable to couple with the plurality of tooth receivers of the adjacent printing sleeve.

9. The mandrel assembly of claim 1 wherein the plurality of printing sleeves comprises:
a first printing sleeve having the engagement mechanism disposed at the second end of the first printing sleeve and an attachment mechanism disposed at the first end of the first printing sleeve, the attachment mechanism for removeably coupling the first printing sleeve to the mandrel so that the first printing sleeve is operable to rotate in conjunction with the mandrel;
a second printing sleeve adjacent the first printing sleeve having a first engagement mechanism disposed at the first end of the second printing sleeve and a second engagement mechanism disposed at the second end of the second printing sleeve, the first engagement mechanism of the second printing sleeve for removeably coupling with the engagement mechanism of the first printing sleeve so that the second printing sleeve is operable to rotate in conjunction with the first printing sleeve; and
a third printing sleeve adjacent the second printing sleeve having the engagement mechanism disposed at the first end of the third printing sleeve for removeably coupling with the second engagement mechanism of the second printing sleeve so that the third printing sleeve is operable to rotate in conjunction with the second printing sleeve and the engagement mechanism of the first printing sleeve when the second printing sleeve is removed from the mandrel assembly so that the third printing sleeve is operable to rotate in conjunction with the first printing sleeve.

10. A mandrel assembly for use in a rotary printing press comprising:
a mandrel having an outer circumference;
a first printing sleeve operable to be disposed along the outer circumference of the mandrel, the first printing sleeve including a first end and a second end, the second end having an engagement mechanism; and
a second printing sleeve operable to be removeably disposed along the outer circumference of the mandrel and adjacent the first printing sleeve, the second printing sleeve including a first end having an engagement mechanism for removeably coupling with the engagement mechanism of the first printing sleeve so that the second printing sleeve is operable to rotate in conjunction with the first printing sleeve when the mandrel is rotated.

11. The mandrel assembly of claim 10 wherein the first end of the first printing sleeve includes an attachment mechanism for coupling the first printing sleeve to the mandrel so that the first printing sleeve is operable to rotate in conjunction with the mandrel.

12. The mandrel assembly of claim 10 wherein the second printing sleeve includes a second end having a second engagement mechanism, the mandrel assembly further comprising a third printing sleeve operable to be removeably disposed along the outer circumference of the mandrel, the third printing sleeve including a first end having an engagement mechanism for removeably coupling to both the second engagement mechanism of the second printing sleeve so that the third printing sleeve is operable to rotate in conjunction with the second printing sleeve when the mandrel is rotated and the engagement mechanism of the first printing sleeve when the second printing sleeve is not disposed along the outer circumference of the mandrel so that the third printing sleeve is operable to rotate in conjunction with the first printing sleeve when the mandrel is rotated.

13. The mandrel assembly of claim 10 wherein the first printing sleeve and the second printing sleeve is a hollow cylindrical tube having an inner circumference, the inner circumference being substantially similar to the outer circumference of the mandrel.

14. The mandrel assembly of claim 13 wherein the mandrel includes air conduits disposed beneath the outer circumference of the mandrel and a plurality of air ports disposed within the outer circumference of the mandrel, the air conduits for pumping air into the mandrel and through the air ports so that the second printing sleeve may slide along the outer circumference of the mandrel to reach a desired position.

15. The mandrel assembly of claim 10 wherein the engagement mechanism of the first printing sleeve includes a plurality of teeth and the engagement mechanism of the second printing sleeve includes a plurality of tooth receivers, the plurality of teeth being operable to removeably couple with the plurality of tooth receivers so that the second printing sleeve is operable to rotate in conjunction with the first printing sleeve when the mandrel is rotated.

16. A method for permitting individual printing sleeves to be selectively replaced on a printing sleeve mandrel assembly comprising the steps of:
providing a mandrel having an outer circumference;
providing a first printing sleeve disposed along the outer circumference of the mandrel, the first printing sleeve including a second end having an engagement mechanism;
providing a second printing sleeve disposed along the outer circumference of the mandrel adjacent the first printing sleeve, the second printing sleeve including a first end having an engagement mechanism;
coupling the engagement mechanism of the first printing sleeve with the engagement mechanism of the second printing sleeve so that the second printing sleeve is operable to rotate in conjunction with the first printing sleeve when the mandrel is rotated;
decoupling the engagement mechanism of the first printing sleeve from the engagement mechanism of the second printing sleeve;
removing the second printing sleeve from the mandrel;
providing a third printing sleeve disposed along the outer circumference of the mandrel and adjacent the first printing sleeve, the second printing sleeve including a first end having an engagement mechanism; and
coupling the engagement mechanism of the third printing sleeve with the engagement mechanism of the first printing sleeve so that the third printing sleeve is operable to rotate in conjunction with the first printing sleeve when the mandrel is rotated.

17. The method of claim 16 further comprising providing an attaching printing sleeve disposed along the outer circumference of the mandrel, the attaching printing sleeve including a first end having an attachment mechanism, the attachment mechanism for coupling the attaching printing sleeve to the mandrel so that the attaching printing sleeve is operable to rotate in conjunction with the mandrel.

18. The method of claim 16 wherein the mandrel includes air conduits disposed beneath the outer circumference of the mandrel and a plurality of air ports disposed within the outer circumference of the mandrel, the method further comprising:
pumping air through the air conduits so that the pumped air is released from the mandrel through the air ports; and
sliding at least one of the first printing sleeve, the second printing sleeve, and the third printing sleeve into a desired position along the outer circumference of the mandrel using the pumped air released through the air ports as a lubricant.

19. The method of claim 18 wherein at least one of the first printing sleeve, the second printing sleeve, and the third printing sleeve includes at least one groove disposed within at least one of the ends for allowing the pumped air to escape the printing sleeve mandrel assembly.

20. The method of claim 19 wherein at least one of the ends of the printing sleeves having one of the grooves includes a slit disposed adjacent the groove for allowing the pumped air released through the air ports to flow through the slit to the groove.
